(19) United States
(12) Patent Application Publication
(10) Pub. No.: US 2019/0085810 A1
(43) Pub. Date: Mar. 21, 2019

(54) ON-BOARD CONTROL SYSTEM AND PORTABLE DEVICE

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventor: Norichika OOMI, Mie (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 16/082,757

(22) PCT Filed: Mar. 13, 2017
(86) PCT No.: PCT/JP2017/009867

§ 371 Date: Sep. 6, 2018

(30) Foreign Application Priority Data
Mar. 25, 2016 (JP) 2016-062336

(51) Int. Cl. F02N 11/08; B60H 1/00; H04W 4/80; G08C 17/02

(52) U.S. Cl. CPC F02N 11/0807; B60H 1/00735; G08C 2201/93; H04W 4/80; G08C 17/02; B60H 1/00657

(57) ABSTRACT

An on-board control system that includes a portable device that transmits a control signal for operating equipment mounted in a vehicle; and an on-board electronic control unit that receives the control signal transmitted from the portable device and operates the equipment on the basis of the received control signal, wherein the portable device includes: a communicator that communicates with an external communicator; an electronic control unit that determines whether or not prescribed communication has been carried out with the external communicator through the communicator; and a transmitter that transmits the control signal for operating the equipment in the case where the electronic control unit determines that the prescribed communication has been carried out.

### TECHNICAL FIELD

The present invention relates to an on-board control system and a portable device that remotely operate equipment mounted in a vehicle, such as an engine.

This disclosure claims priority based on Japanese Patent Application No. 2016-62336, filed Mar. 25, 2016, the entire contents of which are hereby incorporated herein by reference.

### BACKGROUND ART

Engine starting systems are being used commercially as systems that enable a vehicle engine to be started remotely without using a mechanical key. With an engine starting system, when a user operates an operation button (an engine start button) provided in a portable device, a control signal for starting the engine is transmitted from the portable device to an on-board device, and the on-board device that has received the control signal executes control for starting the engine.

Using such an engine starting system, the vehicle engine can be started in advance remotely, which makes it possible to warm up the vehicle, for example. The air conditioner can also be run as necessary, which makes it possible to set the cabin temperature to a comfortable temperature before the user enters the vehicle.

### CITATION LIST

### Patent Documents

Patent Document 1: Japanese Patent No. 4148116

### SUMMARY OF INVENTION

### Technical Problem

However, the above-described engine starting system is configured such that the engine is started by the operation button provided in the portable device being operated. This is problematic in that the portable device must be removed from a bag, a clothes pocket, or the like and operated, which is inconvenient.

Furthermore, the above-described engine starting system requires the user to perform an action of operating the operation button of the portable device. This is problematic in that if the user has forgotten to carry out the operation, the vehicle cannot be warmed up, the cabin temperature cannot be adjusted, and so on.

Having been achieved in light of the foregoing circumstances, an object of the present invention is to provide an on-board control system and a portable device that enable a user to operate equipment mounted in a vehicle, such as the engine, without having to operate an operation button on the portable device.

### Solution to Problem

An on-board control system according to one aspect of the present invention is an on-board control system including a portable device that transmits a control signal for operating equipment mounted in a vehicle, and an on-board control device that receives the control signal transmitted from the portable device and operates the equipment on the basis of the received control signal. The portable device includes: a communication unit that communicates with an external communication device; a determination unit that determines whether or not prescribed communication has been carried out with the external communication device through the communication unit; and a transmission unit that transmits the control signal for operating the equipment in the case where it is determined that the prescribed communication has been carried out.

A portable device according to one aspect of the present invention is a portable device that transmits a control signal for operating equipment mounted in a vehicle, and includes: a communication unit that communicates with an external communication device; a determination unit that determines whether or not prescribed communication has been carried out with the external communication device through the communication unit; and a transmission unit that transmits the control signal for operating the equipment in the case where it is determined that the prescribed communication has been carried out.

### Advantageous Effects of Invention

According to the present application, a user can operate equipment mounted in a vehicle, such as the engine, without having to operate an operation button on the portable device.

### BRIEF DESCRIPTION OF DRAWINGS

FIG. 1 is a schematic diagram illustrating the overall configuration of an on-board control system according to a first embodiment.

FIG. 2 is a block illustrating the internal configuration of the on-board control device.

FIG. 3 is a block diagram illustrating the internal configuration of a portable device.

FIG. 4 is a flowchart illustrating a sequence of processes executed in the on-board control system according to the first embodiment.

FIG. 5 is a schematic diagram illustrating the overall configuration of an on-board control system according to a second embodiment.

FIG. 6 is a block diagram illustrating the internal configuration of a portable device.

FIG. 7 is a flowchart illustrating a sequence of processes executed in the on-board control system according to the second embodiment.

FIG. 8 is a schematic diagram illustrating the overall configuration of an on-board control system according to a third embodiment.

FIG. 9 is a block diagram illustrating the internal configuration of a portable device.

FIG. 10 is a flowchart illustrating a sequence of processes executed in the on-board control system according to the third embodiment.

### DESCRIPTION OF EMBODIMENTS

Embodiments of the present invention will be described as examples. The embodiments described hereinafter may be at least partially combined as desired.

An on-board control system according to one aspect of the present application is an on-board control system including a portable device that transmits a control signal for operating equipment mounted in a vehicle, and an on-board control device that receives the control signal transmitted from the portable device and operates the equipment on the basis of the received control signal. The portable device includes: a communication unit that communicates with an external communication device; a determination unit that determines whether or not prescribed communication has been carried out with the external communication device through the communication unit; and a transmission unit that transmits the control signal for operating the equipment in the case where it is determined that the prescribed communication has been carried out.

According to this aspect, if prescribed communication has been carried out between the portable device and the external communication device, the control signal for operating the equipment is transmitted from the portable device to the vehicle even if the portable device is not being operated.

In an on-board control system according to one aspect of the present application, the prescribed communication is communication according to a set communication method, communication including a set message, or communication including a set communication sequence.

According to this aspect, the control signal for operating the equipment of the vehicle can be transmitted in response to communication including communication according to a set communication method, communication including a set message, or communication including a set communication sequence.

In an on-board control system according to one aspect of the present application, the external communication device is a payment system for paying a fee for a product or a service, and the transmission unit transmits the control signal in the case where the determination unit determines that the prescribed communication has been carried out with the payment system.

According to this aspect, the equipment of the vehicle, such as an air conditioner or the like, can be operated as soon as payment for a purchased product is completed at a business, which makes it possible to carry out on-board control that is more convenient for the user.

In an on-board control system according to one aspect of the present application, the equipment includes an engine or a driving battery system of the vehicle, or an air conditioner or an audio playback device installed in the vehicle.

According to this aspect, if prescribed communication has been carried out between the portable device and the external communication device, a control signal is transmitted from the portable device to the vehicle, and the engine, a driving battery system, an air conditioner, an audio device, or the like can be operated in advance, even if the portable device is not being operated.

A portable device according to one aspect of the present application is a portable device that transmits a control signal for operating equipment mounted in a vehicle, and includes: a communication unit that communicates with an external communication device; a determination unit that determines whether or not prescribed communication has been carried out with the external communication device through the communication unit; and a transmission unit that transmits the control signal for operating the equipment in the case where it is determined that the prescribed communication has been carried out.

According to this aspect, if prescribed communication has been carried out between the portable device and the external communication device, the control signal for operating the equipment is transmitted from the portable device to the vehicle even if the portable device is not being operated.

The present invention will be described in detail hereinafter on the basis of drawings illustrating embodiments thereof.

### First Embodiment

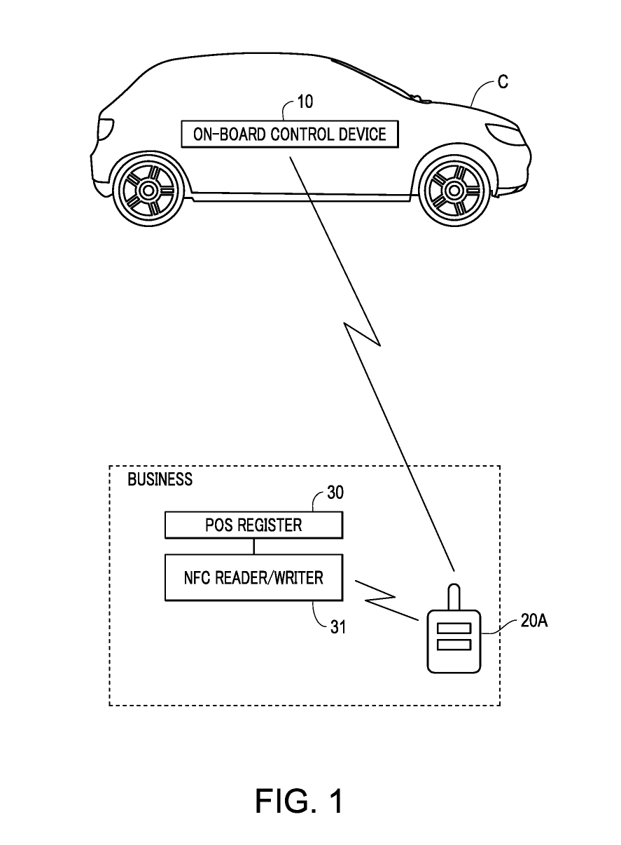

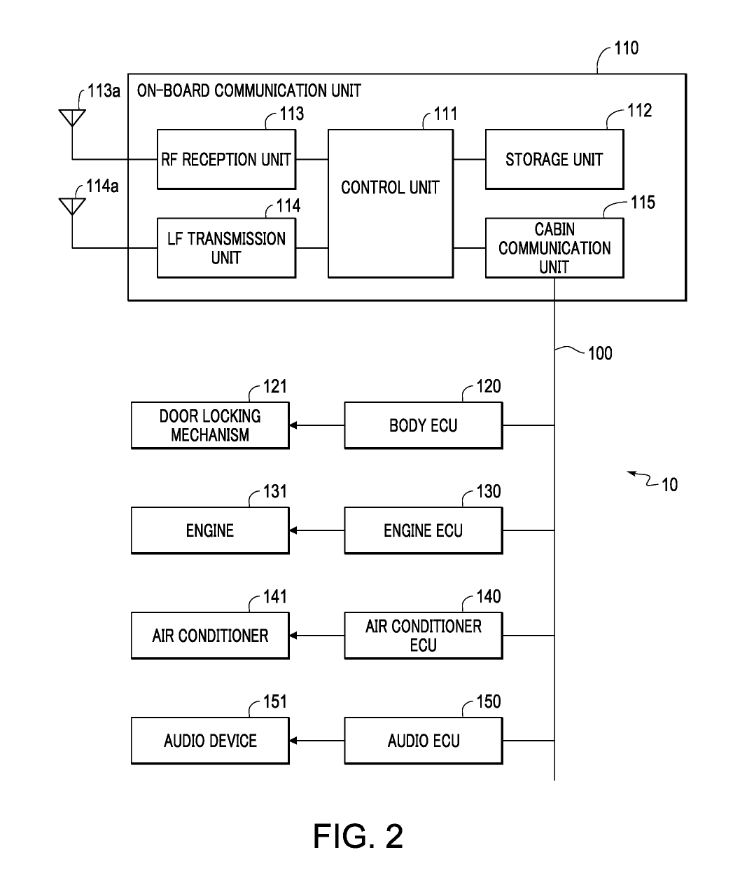

FIG. 1 is a schematic diagram illustrating the overall configuration of an on-board control system according to the first embodiment. The on-board control system according to the first embodiment is installed in a vehicle C, and includes: an on-board control device 10 that controls the operations of equipment such as a door locking mechanism 121, an engine 131, an air conditioner 141, an audio device 151, and the like (see FIG. 2); and a portable device 20A that transmits, to the on-board control device 10, control signals for operating the equipment of the vehicle C.

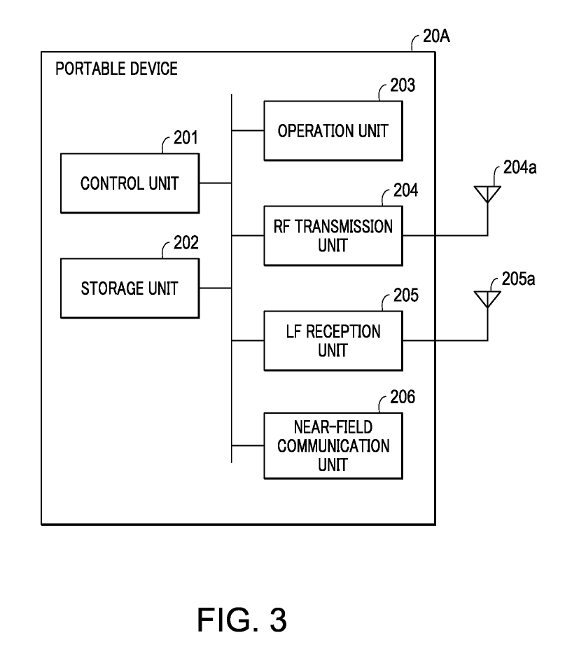

The portable device 20A includes an operation unit 203 (see FIG. 3) for accepting an operation to start the engine 131 of the vehicle C, for example, and is configured to transmit a control signal for starting the engine 131 when the operation unit 203 is operated by a user. The control signal transmitted from the portable device 20A is a signal having a frequency in, for example, an RF band or a specific low-power frequency band, i.e., from 300 to 900 MHz, and has a communication range of approximately from several tens of m to several hundred m.

The on-board control device 10 is configured to control the starting of the engine 131 of the vehicle C upon receiving a control signal transmitted from the portable device 20A. Thus the user can start the engine 131 from a location distanced from the vehicle C by operating the operation unit 203 of the portable device 20A.

In the present embodiment, the portable device 20A has a function for communicating with an external communication device, and is configured to transmit control signals to the on-board control device 10 when carrying out prescribed communication with the external communication device, even when a user operation of the operation unit 203 has not been accepted. The following will describe a configuration in which a control signal for starting the engine 131 is transmitted from the portable device 20A to the on-board control device 10 when prescribed communication is carried out between the portable device 20A and a payment system for paying a fee for a product or a service.

The payment system disclosed in the first embodiment includes, for example: a management server (not illustrated) that manages information of the product or service; a POS (Point of Sales) register 30 connected to the management server by a communication line; and an NFC (Near Field Communication) reader/writer 31. The POS register 30 has a function for calculating and recording the fee for the product or service, a function for communicating with the management server, and so on. The NFC reader/writer 31 is connected to the POS register 30, and has a function for carrying out near-field communication with an NFC chip-equipped mobile telephone carried by a customer or an IC card equipped with an IC tag (a passive tag). In the payment system, customer information is obtained from the NFC chip-equipped mobile telephone or the IC tag-equipped IC card through near-field communication using the NFC reader/writer 31, and a payment process is carried out on the basis of the obtained customer information.

In the first embodiment, the portable device 20A includes a near-field communication unit 206 (see FIG. 3) that carries out near-field communication with the NFC reader/writer 31 so that the stated payment process can be carried out using the portable device 20A. When the user uses the portable device 20A to carry out near-field communication between a business-side NFC reader/writer 31 and the portable device 20A-side near-field communication unit 206, a control signal for starting the engine 131 is transmitted from the portable device 20A to the on-board control device 10.

Note, however, that the portable device 20A need not be a dedicated transmitter for controlling the starting of the engine and the like. The configuration may be such that a terminal device such as a smartphone carried by the user includes the functionality of the portable device 20A according to the present embodiment.

The configurations of the on-board control device 10 and the portable device 20A will be described next.

FIG. 2 is a block illustrating the internal configuration of the on-board control device 10. The on-board control device 10 includes an on-board communication unit 110, a body ECU 120, an engine ECU 130, an air conditioner ECU 140, an audio ECU 150, and so on, which are connected to each other by a CAN bus 100.

The on-board communication unit 110 includes a control unit 111, a storage unit 112, an RF reception unit 113, an LF transmission unit 114, a cabin communication unit 115, and the like.

The control unit 111 is a microcomputer including a CPU (central processing unit), ROM (read-only memory), RAM (random access memory), and so on, for example. The CPU of the control unit 111 controls operations of the hardware included in the on-board communication unit 110 by executing control programs stored in the ROM or the storage unit 112.

The storage unit 112 is constituted by non-volatile memory such as EEPROM (Electronically Erasable Programmable Read Only Memory), and stores control programs for executing wireless communication processing with the portable device 20A, CAN communication process and the like between the ECUs 120 to 150, and so on, for example.

The RF reception unit 113 is connected to an RF reception antenna 113a, and includes a reception circuit that receives signals having RF-band frequencies through the RF reception antenna 113a, a measurement circuit that measures a received signal strength (RSSI; Received Signal Strength Indicator) of the received signal, and so on. In the present embodiment, the RF reception unit 113 receives a control signal transmitted from the portable device 20A through the RF reception antenna 113a, and sends the received control signal to the control unit 111. The control unit 111 carries out a process for authenticating whether or not the control signal received from the RF reception unit 113 is a control signal intended for the control unit 111 itself, and transmits the control signal to the ECU to be controlled (the engine ECU 130, for example) through the cabin communication unit 115 when the authentication succeeds.

The LF transmission unit 114 includes a signal generation circuit that generates signals having LF (Low-Frequency) band frequencies from signals outputted from the control unit 111, an amplifier circuit that amplifies the generated signals, and so on, and transmits the amplified signals to the exterior through an LF transmission antenna 114a. In response to an instruction from the control unit 111, the LF transmission unit 114 transmits, through the LF transmission antenna 114a, a detection signal for detecting the portable device 20A.

The cabin communication unit 115 includes a CAN communication interface, for example, and is communicatively connected to ECUs such as the body ECU 120, the engine ECU 130, the air conditioner ECU 140, and the audio ECU 150 by the CAN bus 100. The cabin communication unit 115 transmits/receives signals among the body ECU 120, the engine ECU 130, the air conditioner ECU 140, and the audio ECU 150 according to the CAN protocol.

The body ECU 120 is connected to the door locking mechanism 121, and carries out control for locking and unlocking vehicle doors (not illustrated) by operating the door locking mechanism 121 on the basis of a control signal transmitted from the on-board communication unit 110, for example.

The engine ECU 130 is connected to the engine 131 of the vehicle C, and carries out control for operating the engine 131 on the basis of a control signal transmitted from the on-board communication unit 110, for example.

The air conditioner ECU 140 is connected to the air conditioner 141, which is provided in the vehicle cabin, and carries out control for operating the air conditioner 141 on the basis of a control signal transmitted from the on-board communication unit 110, for example.

The audio ECU 150 is connected to an audio device 151, which is provided in the vehicle cabin, and carries out control for operating the audio device 151 on the basis of a control signal transmitted from the on-board communication unit 110, for example.

FIG. 3 is a block diagram illustrating the internal configuration of the portable device 20A. The portable device 20A includes a control unit 201, a storage unit 202, the operation unit 203, an RF transmission unit 204, an LF reception unit 205, and the near-field communication unit 206.

The control unit 201 includes a CPU, ROM, and so on, for example. By executing control programs stored in the ROM, the CPU in the control unit 201 controls operations of the hardware included in the portable device 20A, and enables the device as a whole to function as a portable device of the on-board control system according to the present application. Note that the control unit 201 may include the functions of a timer that measures the time elapsed from when a measurement start instruction is supplied to when a measurement end instruction is supplied, a counter for counting numbers, and so on.

The storage unit 202 is constituted by non-volatile memory such as EEPROM, and stores identification information for identifying the portable device 20A. Here, the identification information for identifying the portable device 20A is, for example, an ID number of the portable device 20A, an ID number of the vehicle C in which the on-board control device 10 serving as a communication partner is installed, key information used in encryption processing, and so on.

The operation unit 203 includes an interface for accepting user operations. In the present embodiment, the operation unit 203 includes an operation button for accepting an operation for starting the engine 131 of the vehicle C, for example. The control unit 201 of the portable device 20A sends a control signal instructing the engine to be started to the RF transmission unit 204 when a user operation has been accepted by the operation unit 203.

The RF transmission unit 204 includes a signal generation circuit that generates signals having RF-band frequencies from the control signals outputted from the control unit 201, an amplifier circuit that amplifies the generated signals, and so on, and transmits the amplified signals to the exterior through an RF transmission antenna 204a. In the present embodiment, the RF transmission unit 204 transmits a control signal instructing the engine to be started, inputted from the control unit 201, through the RF transmission antenna 204a.

The LF reception unit 205 is connected to an LF reception antenna 205a, and includes a reception circuit that receives signals having LF-band frequencies through the LF reception antenna 205a, a measurement circuit that measures a signal strength of the received signal, and so on. In the present embodiment, the LF reception unit 205 receives, through the LF reception antenna 205a, the detection signal transmitted from the LF transmission antenna 114a of the vehicle C, and sends the received detection signal to the control unit 201. Upon receiving the detection signal from the LF reception unit 205, the control unit 201 carries out a process for transmitting, through the RF transmission unit 204, a response signal in response to the detection signal.

The near-field communication unit 206 includes an NFC chip, an NFC transmission/reception antenna, and an NFC memory, for example, and is configured to operate under power supplied from the NFC reader/writer 31 through near-field communication. In other words, the configuration is such that electric power is induced when the portable device 20A enters the communication range of the NFC reader/writer (within 10 cm, for example) and the NFC transmission/reception antenna in the near-field communication unit 206 on the portable device 20A side receives radio waves emitted from the NFC reader/writer 31.

The NFC chip of the near-field communication unit 206 obtains a request command from the NFC reader/writer 31 through near-field communication with the NFC reader/writer 31. In response to the request command from the NFC reader/writer 31, the NFC chip of the near-field communication unit 206 executes a process of reading out information stored in the NFC memory, sending the request command to the control unit 201 of the portable device 20A, and so on.

Operations of the on-board control system according to the first embodiment will be described next.

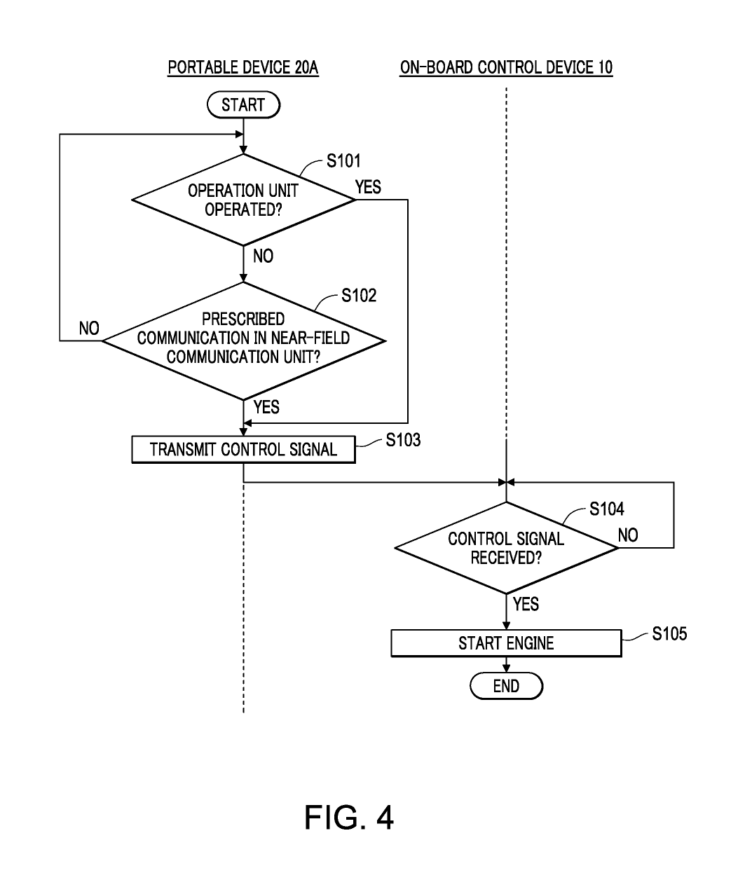

FIG. 4 is a flowchart illustrating a sequence of processes executed in the on-board control system according to the first embodiment. First, the control unit 201 of the portable device 20A determines whether or not the operation unit 203 has accepted a user operation (step S101). If it is determined that the operation unit 203 has accepted a user operation (S101: YES), the control unit 201 executes the process of step S103, which will be described later.

If it is determined that the operation unit 203 has not accepted a user operation (S101: NO), the control unit 201 determines whether or not prescribed communication has been carried out by the near-field communication unit 206 (step S102). Here, the control unit 201 may determine that the prescribed communication has been carried out when near-field communication has been carried out between the near-field communication unit 206 and the NFC reader/writer 31. Additionally, the control unit 201 may determine that the prescribed communication has been carried out when a message indicating that a payment process is complete is included in the near-field communication carried out between the near-field communication unit 206 and the NFC reader/writer 31. Furthermore, the control unit 201 may determine that the prescribed communication has been carried out upon determining that communication has been carried out according to a communication protocol defined in the near-field communication.

If it is determined that the prescribed communication has not been carried out (S102: NO), the control unit 201 returns the process to step S101.

If it has been determined in step S101 that a user operation has been accepted (S101: YES), or if it has been determined in step S102 that the prescribed communication has been carried out (S102: YES), the control unit 201 transmits, through the RF transmission unit 204, a control signal for starting the engine 131 of the vehicle C (step S103).

The control unit 111 of the on-board communication unit 110 periodically determines whether or not the control signal transmitted from the portable device 20A has been received by the RF reception unit 113 (step S104). If it is determined that the control signal has not been received (S104: NO), the control unit 111 stands by until the control signal is received from the portable device 20A.

If it is determined that the control signal has been received from the portable device 20A (S104: YES), the control unit 111 sends the received control signal to the CAN bus 100 and starts the engine 131 through the engine ECU 130 (step S105). Note that the configuration may be such that when the control signal is received from the portable device 20A, an authentication process is carried out to determine whether or not the control signal is from an authentic portable device, and the control signal is sent to the CAN bus 100 only if the authentication is successful.

According to the first embodiment as described thus far, when prescribed communication is carried out between the portable device 20A and the NFC reader/writer 31, which is provided as a payment system for a business, the control signal for starting the engine 131 is transmitted from the portable device 20A to the vehicle C even if the operation unit 203 of the portable device 20A has not been operated. In other words, according to the first embodiment, the engine 131 of the vehicle C can be started in advance, without the user operating the operation unit 203 of the portable device 20A, when payment for purchasing a product or the like at a business is complete and it is thought that the user is highly likely to enter the vehicle C.

The present embodiment describes a configuration in which a control signal is transmitted from the portable device 20A when it is determined that a payment has been completed through communication between the portable device 20A and the NFC reader/writer 31. However, it is not necessarily the case that the user will drive the vehicle C after the payment is completed. Accordingly, a prohibit button may be provided in the portable device 20A, and the transmission of the control signal may be prohibited while the prohibit button is being pressed, even if the prescribed communication has been carried out between the portable device 20A and the NFC reader/writer 31.

Additionally, the present embodiment describes a configuration in which the engine 131 of the vehicle C is started on the basis of a control signal transmitted from the portable device 20A. However, if the vehicle C is an electric automobile or the like driven under power supplied from a driving battery, the configuration may be such that the driving battery is activated on the basis of the control signal transmitted from the portable device 20A.

Additionally, the present embodiment describes a configuration in which the portable device 20A includes the operation unit 203, which accepts an operation for starting the engine 131. However, the configuration may be such that the portable device 20A includes an operation unit for operating the door locking mechanism 121, and a control signal for operating the door locking mechanism 121 is transmitted from the portable device 20A upon that operation unit being operated or upon the near-field communication unit 206 of the portable device 20A carrying out the prescribed communication with the NFC reader/writer 31.

Furthermore, the configuration may be such that the portable device 20A includes an operation unit for operating the air conditioner 141 or the audio device 151, and a control signal for operating the air conditioner 141 or the audio device 151 is transmitted from the portable device 20A upon that operation unit being operated, or upon the near-field communication unit 206 of the portable device 20A carrying out the prescribed communication with the NFC reader/writer 31. In this case, the air conditioner 141 or the audio device 151 of the vehicle C can be turned on as soon as the payment of the fee is completed, which makes it possible to carry out on-board control that is more convenient for the user.

### Second Embodiment

The second embodiment describes a configuration in which when the user of the vehicle C has carried out a payment process using an NFC chip-equipped mobile phone, wireless communication carried out between the mobile phone and the portable device is detected, and a control signal for starting the engine is transmitted from the portable device to the on-board control device 10.

Note that the configuration of the on-board control device 10 is the same as in the first embodiment, and therefore will not be described.

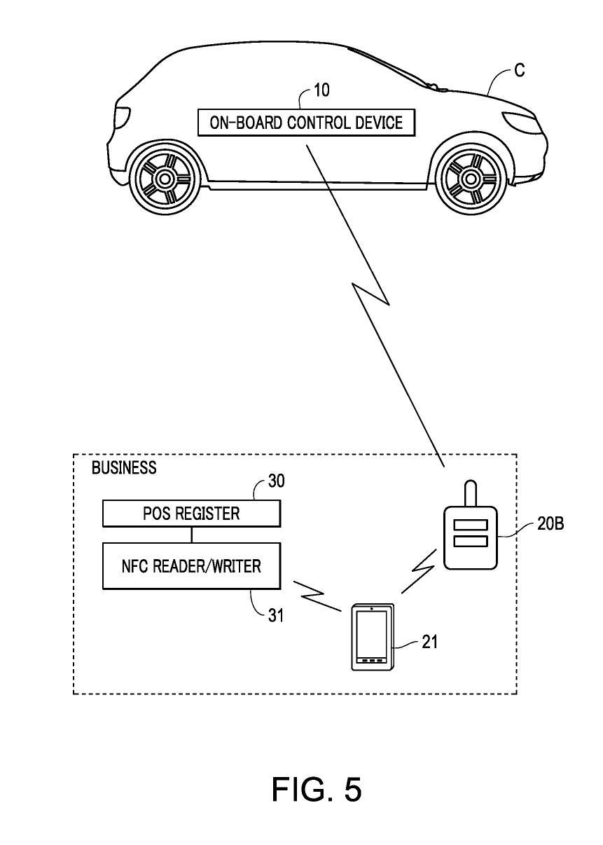

FIG. 5 is a schematic diagram illustrating the overall configuration of an on-board control system according to the second embodiment. The on-board control system according to the second embodiment includes: the on-board control device 10, which is installed in the vehicle C, and controls the operations of equipment such as the door locking mechanism 121, the engine 131, the air conditioner 141, and the audio device 151; and a portable device 20B and a mobile phone 21, which are carried by the user of the vehicle C, the portable device 20B transmitting control signals for operating the equipment of the vehicle C to the on-board control device 10, and the mobile phone 21 being capable of using a business-side payment processing system.

The portable device 20B includes the operation unit 203 for accepting an operation to start the engine 131 of the vehicle C, for example, and is configured to transmit a control signal for starting the engine 131 when the operation unit 203 is operated by the user. The control signal transmitted from the portable device 20B is a signal having a frequency in, for example, an RF band or a specific low-power frequency band, i.e., from 300 to 900 MHz, and has a communication range of approximately from several tens of m to several hundred m.

The on-board control device 10 is configured to control the starting of the engine 131 of the vehicle C upon receiving a control signal transmitted from the portable device 20B. Thus the user can start the engine 131 from a location distanced from the vehicle C by operating the operation unit 203 of the portable device 20B.

In the second embodiment, the portable device 20B has a function for communicating with the mobile phone 21, and is configured to transmit control signals to the on-board control device 10 when carrying out prescribed communication with the mobile phone 21, even when a user operation of the operation unit 203 has not been accepted. Specifically, the configuration is such that when near-field communication for carrying out a payment process between the mobile phone 21 and a payment system for paying a fee for a product or a service has been carried out, wireless communication is carried out between the mobile phone 21 and the portable device 20B using Bluetooth (registered trademark) or wireless LAN, and a control signal for starting the engine 131 is transmitted from the portable device 20B to the on-board control device 10 in response to that wireless communication.

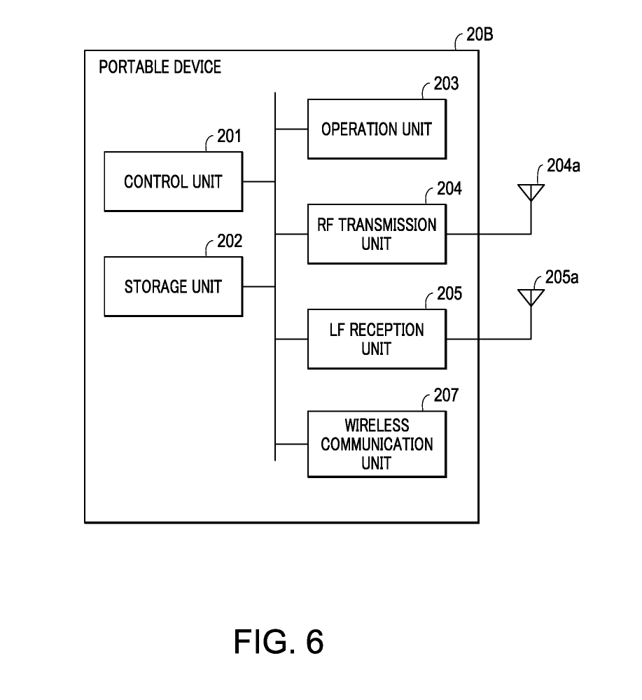

FIG. 6 is a block diagram illustrating the internal configuration of the portable device 20B. The portable device 20B includes a wireless communication unit 207 in addition to the above-described control unit 201, storage unit 202, operation unit 203, RF transmission unit 204, and LF reception unit 205.

The wireless communication unit 207 has a function for carrying out wireless communication with a separate paired communication device (the mobile phone 21, in the second embodiment) over Bluetooth (registered trademark), or a function for connecting to a wireless LAN and carrying out wireless communication with another communication device (the mobile phone 21) over the wireless LAN.

Operations of the on-board control system according to the second embodiment will be described next.

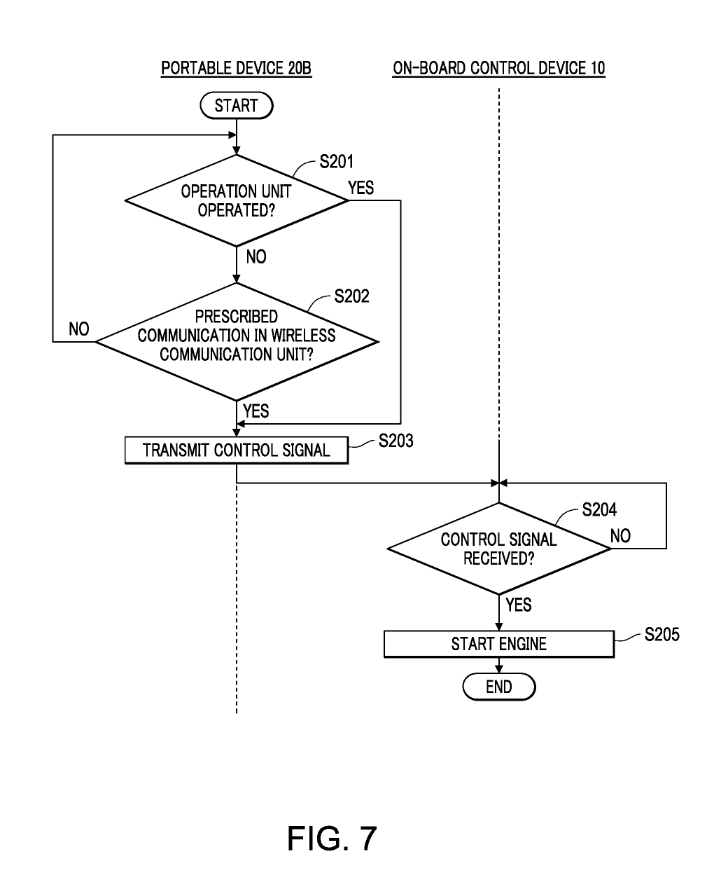

FIG. 7 is a flowchart illustrating a sequence of processes executed in the on-board control system according to the second embodiment. First, the control unit 201 of the portable device 20B determines whether or not the operation unit 203 has accepted a user operation (step S201). If it is determined that the operation unit 203 has accepted a user operation (S201: YES), the control unit 201 executes the process of step S203, which will be described later.

If it is determined that the operation unit 203 has not accepted a user operation (S201: NO), the control unit 201 determines whether or not prescribed communication has been carried out by the wireless communication unit 207 (step S202). Here, the control unit 201 may determine that the prescribed communication has been carried out when wireless communication has been carried out between the wireless communication unit 207 and a mobile phone 21 over Bluetooth (registered trademark) or wireless LAN. Additionally, the control unit 201 may determine that the prescribed communication has been carried out when it is determined that a message indicating that a payment process is complete has been received by the wireless communication unit 207 from the mobile phone 21. Furthermore, the control unit 201 may determine that the prescribed communication has been carried out upon determining that communication has been carried out according to a communication protocol defined by Bluetooth (registered trademark) or wireless LAN.

If it is determined that the prescribed communication has not been carried out (S202: NO), the control unit 201 returns the process to step S201.

If it has been determined in step S201 that a user operation has been accepted (S201: YES), or if it has been determined in step S202 that the prescribed communication has been carried out (S202: YES), the control unit 201 transmits, through the RF transmission unit 204, a control signal for starting the engine 131 of the vehicle C (step S203).

The control unit 111 of the on-board communication unit 110 periodically determines whether or not the control signal transmitted from the portable device 20B has been received by the RF reception unit 113 (step S204). If it is determined that the control signal has not been received (S204: NO), the control unit 111 stands by until the control signal is received from the portable device 20B.

If it is determined that the control signal has been received from the portable device 20B (S204: YES), the control unit 111 sends the received control signal to the CAN bus 100 and starts the engine 131 through the engine ECU 130 (step S205). Note that the configuration may be such that when the control signal is received from the portable device 20B, an authentication process is carried out to determine whether or not the control signal is from an authentic portable device, and the control signal is sent to the CAN bus 100 only if the authentication is successful.

According to the second embodiment as described thus far, when prescribed communication is carried out between the mobile phone 21 and the portable device 20B after the payment process, the control signal for starting the engine 131 is transmitted from the portable device 20B to the vehicle C even if the operation unit 203 of the portable device 20B has not been operated. In other words, according to the second embodiment, the engine 131 of the vehicle C can be started in advance, without the user operating the operation unit 203 of the portable device 20B, when payment for purchasing a product or the like at a business is complete and it is thought that the user is highly likely to enter the vehicle C.

The present embodiment describes a configuration in which a control signal is transmitted from the portable device 20B when it is determined that payment has been completed through communication between the portable device 20B and the mobile phone 21. However, it is not necessarily the case that the user will drive the vehicle C after the payment is completed. Accordingly, a prohibit button may be provided in the portable device 20B, and the transmission of the control signal may be prohibited while the prohibit button is being pressed, even if communication has been carried out between the portable device 20B and the mobile phone 21.

Additionally, the present embodiment describes a configuration in which the engine 131 of the vehicle C is started on the basis of a control signal transmitted from the portable device 20B. However, if the vehicle C is an electric automobile or the like driven under power supplied from a driving battery, the configuration may be such that the driving battery is activated on the basis of the control signal transmitted from the portable device 20B.

Furthermore, the present embodiment describes a configuration in which the portable device 20B includes the operation unit 203, which accepts an operation for starting the engine 131. However, the configuration may be such that the portable device 20B includes an operation unit for operating the door locking mechanism 121, and a control signal for operating the door locking mechanism 121 is transmitted from the portable device 20B upon that operation unit being operated or upon the prescribed communication being carried out between the portable device 20B and the mobile phone 21.

Furthermore, the configuration may be such that the portable device 20B includes an operation unit for operating the air conditioner 141 or the audio device 151, and a control signal for operating the air conditioner 141 or the audio device 151 is transmitted from the portable device 20B upon that operation unit being operated, or upon the prescribed communication being carried out between the portable device 20B and the mobile phone 21.

### Third Embodiment

A third embodiment describes a configuration that uses a detection system for detecting whether or not the user is passing through a designated region, where the control signal for starting the engine is transmitted from the portable device to the on-board control device 10 when wireless communication has been carried out between the detection system and the portable device.

Note that the configuration of the on-board control device 10 is the same as in the first embodiment, and therefore will not be described.

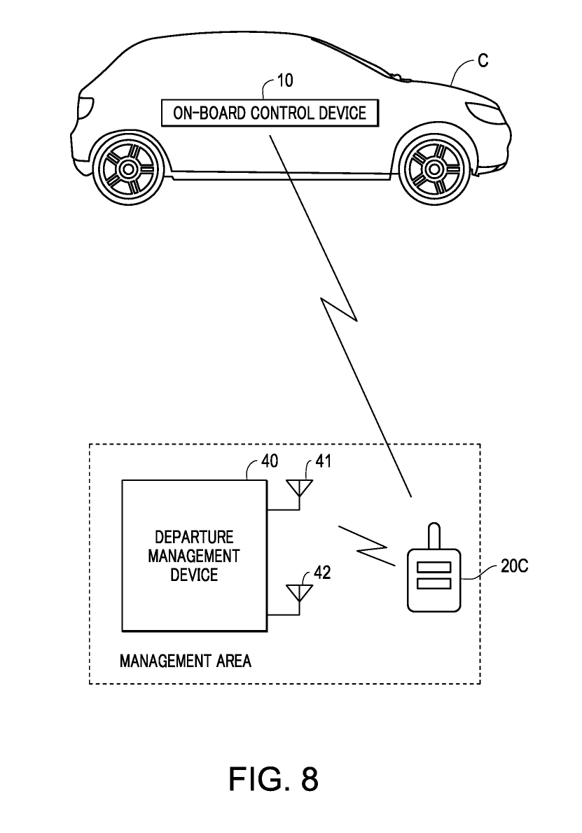

FIG. 8 is a schematic diagram illustrating the overall configuration of an on-board control system according to the third embodiment. The on-board control system according to the third embodiment is installed in the vehicle C, and includes: the on-board control device 10 that controls the operations of equipment such as the door locking mechanism 121, the engine 131, the air conditioner 141, the audio device 151, and the like; and a portable device 20C that transmits, to the on-board control device 10, control signals for operating the equipment of the vehicle C.

The portable device 20C includes the operation unit 203 for accepting an operation to start the engine 131 of the vehicle C, for example, and is configured to transmit a control signal for starting the engine 131 when the operation unit 203 is operated by the user. The control signal transmitted from the portable device 20C is a signal having a frequency in, for example, an RF band or a specific low-power frequency band, i.e., from 300 to 900 MHz, and has a communication range of approximately from several tens of m to several hundred m.

The on-board control device 10 is configured to control the starting of the engine 131 of the vehicle C upon receiving a control signal transmitted from the portable device 20C. Thus the user can start the engine 131 from a location distanced from the vehicle C by operating the operation unit 203 of the portable device 20C.

The portable device 20C according to the third embodiment is configured to carry out wireless communication with a departure management device 40 that manages the departure of the user from a pre-set region (management area), and is configured to transmit control signals to the on-board control device 10 when prescribed communication is carried out with the departure management device 40, even when the operation unit 203 has not accepted a user operation.

The departure management device 40 is provided at an exit/entrance of a building, a ticket gate in a station, or the like. In order to detect the user carrying the portable device 20C, the departure management device 40 includes: an LF transmission antenna 41 that transmits an LF-band signal at prescribed intervals of time; and an RF reception antenna 42 that receives an RF-band response signal transmitted from the portable device 20C that has received the signal transmitted from the LF transmission antenna 41. In the third embodiment, the configuration is such that it is determined that the prescribed communication has been carried out upon the portable device 20C receiving a signal transmitted from the LF transmission antenna 41 of the departure management device 40, and a control signal for starting the engine 131 is transmitted from the portable device 20C to the on-board control device 10.

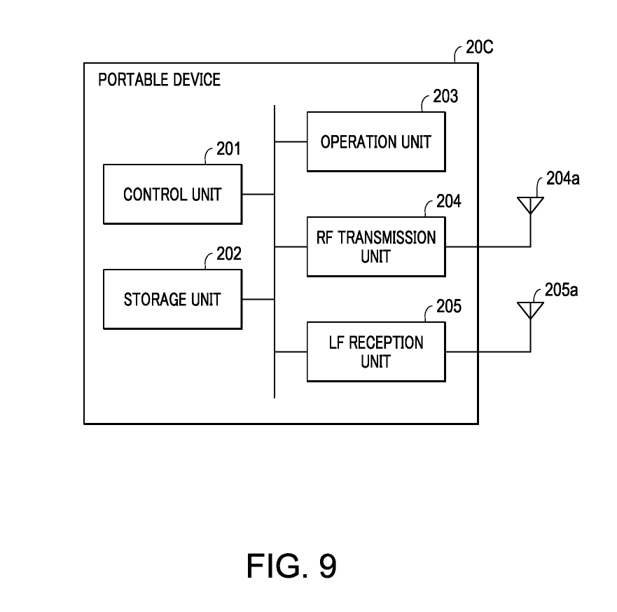

FIG. 9 is a block diagram illustrating the internal configuration of the portable device 20C. The portable device 20C includes the above-described control unit 201, storage unit 202, operation unit 203, RF transmission unit 204, and LF reception unit 205.

The LF reception unit 205 is configured to receive not only signals from the LF transmission unit 114 included in the on-board communication unit 110 of the on-board control device 10, but also the LF-band signals transmitted from the departure management device 40.

Additionally, the RF transmission unit 204 is configured to transmit a response signal in response to the LF reception unit 205 receiving an LF-band signal transmitted from the LF transmission unit 114 of the on-board communication unit 110 or an LF-band signal transmitted from the departure management device 40.

Operations of the on-board control system according to the third embodiment will be described next.

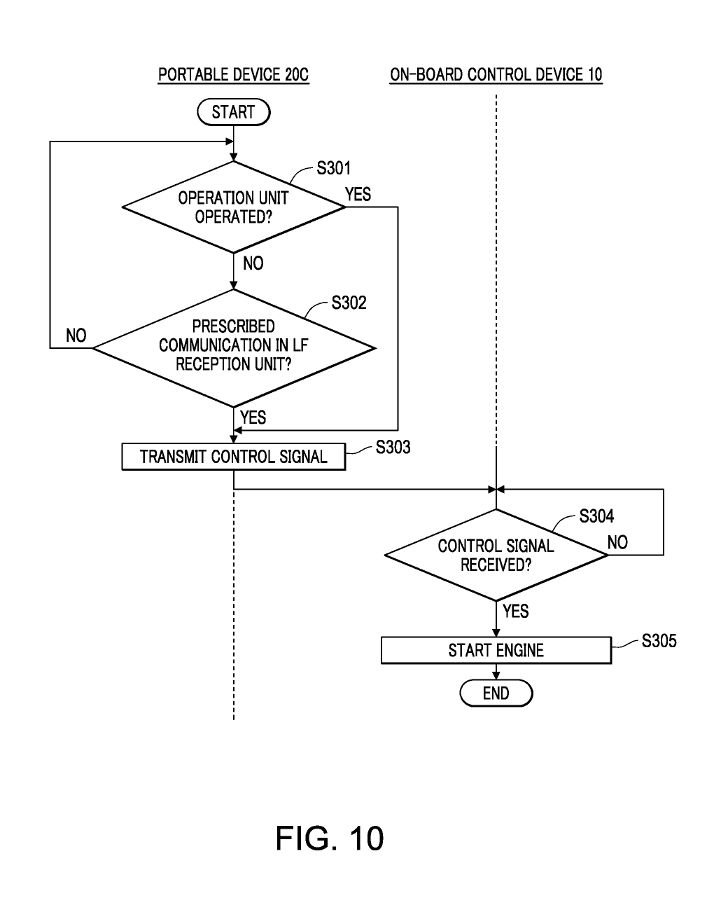

FIG. 10 is a flowchart illustrating a sequence of processes executed in the on-board control system according to the third embodiment. First, the control unit 201 of the portable device 20C determines whether or not the operation unit 203 has accepted a user operation (step S301). If it is determined that the operation unit 203 has accepted a user operation (S301: YES), the control unit 201 executes the process of step S303, which will be described later.

If it is determined that the operation unit 203 has not accepted a user operation (S301: NO), the control unit 201 determines whether or not prescribed communication has been carried out by the LF reception unit 205 (step S302). Here, the control unit 201 may determine that the prescribed communication has been carried out when the LF reception unit 205 has received an LF-band signal from the departure management device 40.

Additionally, the control unit 201 may determine that the prescribed communication has been carried out when a message including information for identifying the departure management device 40 has been received by the LF reception unit 205 as transmission source identification information.

Furthermore, the control unit 201 may determine that the prescribed communication has been carried out upon determining that communication has been carried out according to a communication protocol defining a sequence for transmitting/receiving LF-band signals.

If it is determined that the prescribed communication has not been carried out (S302: NO), the control unit 201 returns the process to step S301.

If it has been determined in step S301 that a user operation has been accepted (S301: YES), or if it has been determined in step S302 that the prescribed communication has been carried out (S302: YES), the control unit 201 transmits, through the RF transmission unit 204, a control signal for starting the engine 131 of the vehicle C (step S303).

The control unit 111 of the on-board communication unit 110 periodically determines whether or not the control signal transmitted from the portable device 20C has been received by the RF reception unit 113 (step S304). If it is determined that the control signal has not been received (S304: NO), the control unit 111 stands by until the control signal is received from the portable device 20C.

If it is determined that the control signal has been received from the portable device 20C (S304: YES), the control unit 111 sends the received control signal to the CAN bus 100 and starts the engine 131 through the engine ECU 130 (step S305). Note that the configuration may be such that when the control signal is received from the portable device 20C, an authentication process is carried out to determine whether or not the control signal is from an authentic portable device, and the control signal is sent to the CAN bus 100 only if the authentication is successful.

According to the third embodiment as described thus far, when prescribed communication is carried out with the departure management device 40, the control signal for starting the engine 131 is transmitted from the portable device 20C to the vehicle C even if the operation unit 203 of the portable device 20C has not been operated. In other words, according to the third embodiment, the engine 131 of the vehicle C can be started in advance, without the user operating the operation unit 203 of the portable device 20C, when the user has departed the management area and it is thought that the user is highly likely to enter the vehicle C.

The present embodiment describes a configuration in which a control signal is transmitted from the portable device 20C when it is determined that communication has been carried out between the portable device 20C and the departure management device 40. However, it is not necessarily the case that the user will drive the vehicle C after departing the management area. Accordingly, a prohibit button may be provided in the portable device 20C, and the transmission of the control signal may be prohibited while the prohibit button is being pressed, even if communication has been carried out between the portable device 20C and the departure management device 40.

Additionally, the present embodiment describes a configuration in which the engine 131 of the vehicle C is started on the basis of a control signal transmitted from the portable device 20C. However, if the vehicle C is an electric automobile or the like driven under power supplied from a driving battery, the configuration may be such that the driving battery is activated on the basis of the control signal transmitted from the portable device 20C.

Furthermore, the present embodiment describes a configuration in which the portable device 20C includes the operation unit 203, which accepts an operation for starting the engine 131. However, the configuration may be such that the portable device 20C includes an operation unit for operating the door locking mechanism 121, and a control signal for operating the door locking mechanism 121 is transmitted from the portable device 20C upon that operation unit being operated or upon the prescribed communication being carried out between the portable device 20C and the departure management device 40. Furthermore, the configuration may be such that the portable device 20C includes an operation unit for operating the air conditioner 141 or the audio device 151, and a control signal for operating the air conditioner 141 or the audio device 151 is transmitted from the portable device 20C upon that operation unit being operated, or upon the prescribed communication being carried out between the portable device 20C and the departure management device 40.

The embodiments disclosed here are intended to be in all ways exemplary and in no ways limiting. The scope of the present invention is defined not by the foregoing descriptions but by the scope of the claims, and is intended to include all changes equivalent in meaning to and falling within the scope of the claims.

### REFERENCE SIGNS LIST

C vehicle
10 on-board control device
20A, 20B, 20C portable device
30 POS register
31 NFC reader/writer
40 departure management device
100 CAN bus
110 on-board communication unit
111 control unit
112 storage unit
113 RF reception unit
114 LF transmission unit
115 cabin communication unit
120 body ECU
121 door locking mechanism
130 engine ECU
131 engine
140 air conditioner ECU
141 air conditioner
150 audio ECU
151 audio device
201 control unit
202 storage unit
203 operation unit
204 RF transmission unit
205 LF reception unit
206 near-field communication unit

1. An on-board control system comprising:
a portable device that transmits a control signal for operating equipment mounted in a vehicle; and
an on-board electronic control unit that receives the control signal transmitted from the portable device and operates the equipment on the basis of the received control signal,
wherein the portable device includes:
a communicator that communicates with an external communicator;
an electronic control unit that determines whether or not prescribed communication has been carried out with the external communicator through the communicator; and
a transmitter that transmits the control signal for operating the equipment in the case where the electronic control unit determines that the prescribed communication has been carried out.

2. The on-board control system according to claim 1,
wherein the prescribed communication is communication according to a set communication method, communication including a set message, or communication including a set communication sequence.

3. The on-board control system according to claim 1,
wherein the external communicator is a payment system for paying a fee for a product or a service; and
the transmitter transmits the control signal in the case where the electronic control unit determines that the prescribed communication has been carried out with the payment system.

4. The on-board control system according to claim 1,
wherein the equipment includes an engine or a driving battery system of the vehicle, or an air conditioner or an audio playback device installed in the vehicle.

5. A portable device that transmits a control signal for operating equipment mounted in a vehicle, the device comprising:
a communicator that communicates with an external communicator;
an electronic control unit that determines whether or not prescribed communication has been carried out with the external communicator through the communicator; and
a transmitter that transmits the control signal for operating the equipment in the case where the electronic control unit determines that the prescribed communication has been carried out.
